(19) United States
(12) Patent Application Publication
(10) Pub. No.: US 2009/0135681 A1
(43) Pub. Date: May 28, 2009

(54) Watchband Shims

(76) Inventor: Brad Lawson, Elk Grove, CA (US)

Correspondence Address: Ken Campbell, PO Box 551, Fair Oaks, CA, 95628, US

(21) Appl. No.: 12/272,721

(22) Filed: Nov. 17, 2008

Related U.S. Application Data
(60) Provisional application No. 60/988,740, filed on Nov. 16, 2007.

(51) Int. Cl. G04B 37/14

(52) U.S. Cl. 368/282

(57) ABSTRACT

A watch accessory that prevents physical injury and discomfort to the skin, while ensuring a snug, comfortable, and stylish fit for large metal watches, is finally disclosed.

This application claims the benefit of priority given by U.S. Provisional Patent Application No. 60/988,740, having a filing date of Nov. 16, 2007 for Bradford Lawson.

### SUMMARY

As technology continues to advance, more and more devices are becoming miniaturized. In fact, it is common to see a single item, reduced in size (such as the cellular phone) with a number of other devices built into it. However, there is a natural limit to how small a consumer product can get, before the disadvantages begin to outweigh the advantages. Yet, it is also obvious that the “Dick Tracy Watch” of the future, is right around the corner. But already, comfort is becoming a critical factor.

This invention relates to a means for providing a comfortable fit for a watchband or bracelet. A solid watch with a metal band (usually having sharp square edges) has become a benchmark in durability and style. As watches evolve to contain more and more features, the pinnacle design for a durably accurate timepiece becomes heavier and heavier. This added weight causes the metal watchband to dig into the skin of the wearer, leaving marks and injury. The need to accommodate that change to heavier watches, in terms of comfort, has not been adequately addressed until now.

Most watchbands, particularly metal ones, have limited adjustability. Normally adjustment is limited to a handful of positions to which one end of the band may be fastened. There have been attempts to improve the adjustability of these watchbands. For example, U.S. Pat. No. 3,149,452 to Smith attempts to add cushion and space behind the timepiece itself. This only makes the watch less comfortable, because it actually causes the watchband to dig further into the skin. Another example of the is U.S. Pat. No. 6,499,875 to Telly. By using something other than an soft, forgiving material, Telly actually makes the problem even worse.

This present invention lets the wearer adjust the length of the watchband to an optimal fit, while preventing the sharp edges of the band itself from gouging, or digging into the skin.

In the past, equipment has been provided to prevent watches from slipping around the wrist, as well. But, this equipment was provided at the expense of style and appearance. (An example of this is U.S. Pat. No. 2,114,466 to Fletcher.) In addition, one's wrist size actually changes slightly from one season to the next.

With earlier technology, it has been simply not possible to achieve a comfortable fit all the time, with a typical watchband, even with training devices attached. Now, a simple set of articles makes it possible for the first time, to enjoy the unaffected appearance of any designer timepiece in combination with year-round, exacting comfort. The comfort derives from the cushioning between the skin and the sharp edges of the watchband.

The invention is a pair of thin pliable strips shaped to fit within the visible edges of a nonexpanding watchband, so that the strips remain non-visible during use. The material used can be anywhere from 1/64″ to 3/16″ thick. The strips are each of differing surface area, having a particular thickness that modifies the overall inner circumference of the band. The strips (which differ in size with respect to each other) can be used one at a time, or both together, providing three possible fit adjustments for any given watchband length. They can be molded, extruded, or cut from stock sheet material (rubber, polyurethane, etc).

The strips are secured to the interior surface of a non-expanding watchband by an appropriate adhesive, and left to stay until removed. Since the strips are pliable, they provide cushion to the wrist at the most critical areas while remaining flexible enough to accommodate change in the shape of the wrist (caused by muscular movement).

Prior technology to which this invention relates is hereby incorporated by reference, from the art listed within this patent specification.

### DESCRIPTION OF THE DRAWING VIEWS

FIG. 1 shows a perspective view of the invention as it is installed on a typical metal watchband.

FIG. 2 shows a back view of the invention as it is installed on a typical metal watchband.

FIG. 3 shows a top section view of the invention.

FIG. 4 shows an end section view of the invention.

FIG. 5 shows a side section view of the invention.

### DESCRIPTION

FIG. 1 shows the invention after it is installed onto a typical watch 3. The invention is made up of two pads, a larger and a smaller. The Larger Pad 1 is located on the longer portion of watchband, and the Smaller Pad 2 is located on the shorter portion of watchband. In this figure, the watch is shown with both pads installed. This arrangement allows the skin of the user to be most protected from the sharp metal edges of the watchband itself. Take special note that the edges at the back of the timepiece itself are normally raised off of the wrist by the thickness of the service (battery) cover, and do not normally come into contact with the flesh of the user. It is only the edges of the watchband itself that normally dig into the User's skin. The invention, a set of watchband shims raises the sharp edges of the band off of the skin and prevent injury.

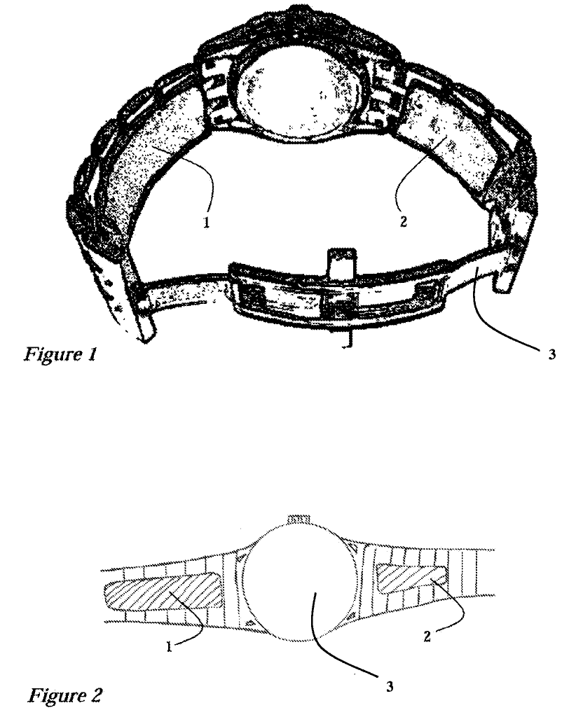

FIG. 2 show the open view of the invention after it is installed onto a typical watch. In this view, it can be seen that the Larger Pad 1 is of a greater area than the Smaller Pad 2. This feature allows for three separate adjustments between the normal gross adjustments of an un-shimmed watch. When only the Smaller Pad is installed, then the effective inner circumference of the watch is reduced a minimal amount. If only the Larger Pad is installed, then the inner circumference is reduced by a greater amount. And of course, if both pads are installed, then the circumference is reduced by the greatest amount.

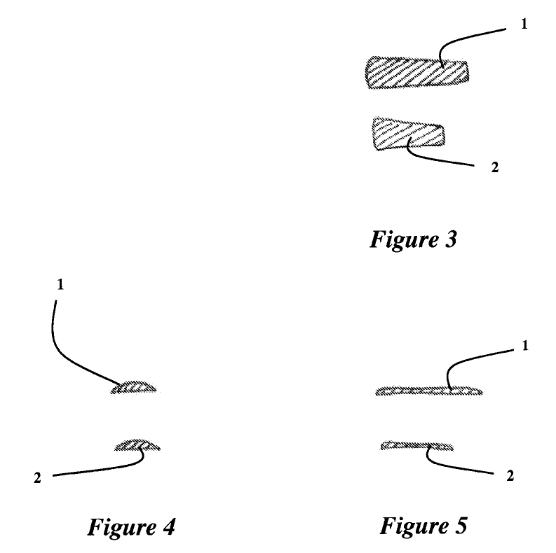

FIG. 3 shows the top views of the Larger Pad 1 and the Smaller Pad 2.

FIG. 4 shows the end views of the Larger Pad 1 and the Smaller Pad 2.

FIG. 5 shows the side views of the Larger Pad 1 and the Smaller Pad 2.

1. A set of watchband shims comprising a first pad of cushion material and a second pad of cushion material, a means of adhesive applied to one side of each pad, so as to allow the set to relieve a watch wearer of physical injury and discomfort, by shimming the band of said watch away from the skin of said user.
